SEQUENCE LISTING (1 sequence)

SEQ ID NO: 1 - protein, 24 aa, Arabidopsis thaliana
FGSLVLNALPKGSVPASGPSKRIN

(19) United States
(12) Patent Application Publication
(10) Pub. No.: US 2022/0346375 A1
(43) Pub. Date: Nov. 3, 2022

(54) IDL6 MATURE POLYPEPTIDE PLANT AGING PROMOTER, AND PREPARATION METHOD AND APPLICATION THEREOF

(71) Applicant: TOBACCO RESEARCH INSTITUTE OF CHINESE ACADEMY OF AGRICULTURAL SCIENCES, Qingdao (CN)

(72) Inventors: YONGFENG GUO, QINGDAO (CN); CUN GUO, QINGDAO (CN); QI WANG, QINGDAO (CN); WEI LI, QINGDAO (CN); ZENGLIN ZHANG, QINGDAO (CN); LICHAO WEN, QINGDAO (CN); ZHICHAO DENG, QINGDAO (CN); TAO LIU, QINGDAO (CN)

(21) Appl. No.: 17/838,113

(22) Filed: Jun. 10, 2022

Related U.S. Application Data
(63) Continuation of application No. PCT/CN2021/129016, filed on Nov. 5, 2021.

(30) Foreign Application Priority Data
Nov. 27, 2020 (CN) 202011358266.5

(51) Int. Cl. A01N 37/46; A01N 43/84; A01P 21/00

(52) U.S. Cl. CPC A01N 37/46; A01N 43/84; A01P 21/00

(57) ABSTRACT

The present application an IDL6 mature polypeptide plant aging promoter, and a preparation method and application thereof, belonging to the field of plant aging promoters. The IDL6 mature polypeptide plant aging promoter is with an IDL6 mature polypeptide as a main functional component, and the IDL6 mature polypeptide having the following amino acid sequence: F-G-S-L-V-L-N-A-L-P-K-G-S-V-P-A-S-G-P-S-K-R-I-N. The provided plant aging promoter can promote the leaf senescence of the plant, accelerate the senescence, and has no other additional bad performance, and has extremely strong field operability.

### CROSS-REFERENCE TO RELATED APPLICATIONS

The present application is a continuation of the international application PCT/CN2021/129016 filed on Nov. 5, 2021, which claims the priority benefit of Chinese application No. 202011358266.5, filed on Nov. 27, 2020, entitled “IDL6 mature polypeptide plant aging promoter, and preparation method and application thereof”, the entirety of the above identified applications is hereby incorporated by reference.

### TECHNICAL FIELD

The present application belongs to the field of plant aging promoters, and particularly relates to an IDL6 mature polypeptide plant aging promoter, and a preparation method and application thereof.

### BACKGROUND ART

Leaf aging is an important factor that affects the yield, quality or other agronomic traits of crops. Taking tobacco as an example, leaves are the harvesting organ of tobacco. As tobacco enters the late growth stage, the leaves enter the aging stage. The leaves in upper, middle and lower parts of tobacco have different mature periods. If a strategy of harvesting different parts in different periods is employed, the harvesting time will be delayed. However, by using aging promoters, the problems of inconsistent maturity and turning green of tobacco leaves at different parts can be effectively solved.

At present, the application of plant aging control mainly focuses on the plant hormones. For instance, auxin and cytokinin could inhibit leaf aging, while ethylene and abscisic acid could promote leaf aging. The leaf senescence process can be artificially delay when the aging rules have been known well. The aging-related functional analysis has been widely and deeply carried out, and a large number of genes that promote leaf aging have been functionally analyzed. Hu, et al found that the deletion of 2-oxoglutarate-dependent dioxygenase gene in Arabidopsis thaliana wound delay the phenotype of leaf aging, and dexamethasone (DEX) could advance the aging of transgenic Arabidopsis thaliana leaves after inducing the overexpression of this gene. Guo, et al found that the overexpression of the NAP gene could advance leave aging while nap mutant delay leaves aging. Similarly, NAP could also affect leaf aging in rice.

Polypeptide is a class of small molecular substances with a regulatory function in animals and plants. Mature polypeptide is a functional molecule consisting of only short amino acids, which is finally formed by translation, shearing and modifying the to precursor protein; and serves as a ligand to recognize and initiate signal transduction with the receptor located on the cell membrane.

### SUMMARY OF THE PRESENT INVENTION

The present application provides an IDL6 mature polypeptide plant aging promoter (called a plant aging promoter for short hereinafter), and a preparation method and application thereof. The IDL6 mature polypeptide plant aging promoter can promote the leaf aging of plants and accelerate the aging of plant leave, without other additional adverse performances. IDL6. is short for inflorescence deficient in abscission (IDA)—like 6.

In order to solve some of the above technical problems, the present application provides an IDL6 mature polypeptide plant aging promoter, with an IDL6 mature polypeptide as a main functional component, and the IDL6 mature polypeptide having the following amino acid sequence as in SEQ ID No.1:

F-G-S-L-V-L-N-A-L-P-K-G-S-V-P-A-S-G-P-S-K-R-I-N.

In which F is the abbreviation of Phe; G is the abbreviation of Gly; S is the abbreviation of Ser; L is the abbreviation of Leu; V is the abbreviation of Val; N is the abbreviation of Asn; A is the abbreviation of Ala; P is the abbreviation of Pro; K is the abbreviation of Lys; R is the abbreviation of Arg; and I is the abbreviation of Ile.

The material in the ASCI text file of the sequence listing of the above amino acid sequence SEQ ID No.1 is herewith incorporated by reference. The ASCI text file was created on March 24, 2022 and has a file name “Sequence Listing 1” and a size of 546 bytes.

In some embodiments of the present application, the plant aging promoter includes the IDL6 mature polypeptide and a 2-(N-morpholino)ethanesulfonic acid solution, wherein the 2-(N-morpholino)ethanesulfonic acid solution is a solution obtained by dissolving 2-(N-morpholino)ethanesulfonic acid monohydrate in an MS liquid culture medium. It should be understood that the use of 2-(N-morpholino)ethanesulfonic acid as a solvent to dissolve the IDL6 mature polypeptide is because the 2-(N-morpholino)ethanesulfonic acid is a novel biological buffer that can better facilitate polypeptide to provide corresponding functions.

In some embodiments of the present application, the concentration of the IDL6 mature polypeptide in the plant aging promoter is 10-13 μmol/L, the concentration of 2-(N-morpholino)ethanesulfonic acid in the 2-(N-morpholino)ethanesulfonic acid is solution is 2.8-3 mmol/L, and the pH of the 2-(N-morpholino)ethanesulfonic acid solution is 5.8-5.9. It should be understood that, the concentration of the IDL6 mature polypeptide may be 10, 11, 12 or 13 μmol/L, the concentration of 2-(N-morpholino)ethanesulfonic acid in the 2-(N-morpholino)ethanesulfonic acid solution may be 2.8, 2.9 or 3 mmol/L, and the pH of the 2-(N-morpholino)ethanesulfonic acid solution may be 5.8 or 5.9.

In some embodiments of the present application, the plant aging promoter further includes an auxiliary agent. The auxiliary agent may be a conventional auxiliary agent used for the wetting and extension of leaf surfaces in the art, and will not be specifically limited in the present technical solution as long as it can enable the solution to be spread and infiltrated on a plant surface as soon as possible. It should be understood that the auxiliary agent may be Tween-20, and the added amount of the auxiliary agent is 1-2 v/v ‰. Tween-20 is a surfactant, also known as polyoxyethylene sorbitan monolaurate, with CAS No. 9005-64-5.

The present application further provides a preparation method for the IDL6 mature polypeptide plant aging promoter, specifically including the following steps.

S1: Dissolving IDL6 mature polypeptide power in water to prepare an IDL6 mature polypeptide mother solution.

S2: Adding a certain amount of 2-(N-morpholino)ethanesulfonic acid monohydrate to a prepared MS liquid culture medium to prepare 2-(N-morpholino)ethanesulfonic acid solution, adjusting the pH value of the solution, and mixing the solution fully to obtain the 2-(N-morpholino)ethanesulfonic acid solution after evenly dissolved.

The MS liquid culture medium is a Murashige and Skoog (MS) liquid culture medium. The MS culture medium power (not containing agar and sucrose) used in the above step is from Beijing Solarbio Science & Technology Co., Ltd. When in use, 4.42 g of the power is dissolved in 1 L of water to obtain the MS liquid culture medium. The culture medium can fully dissolve 2-(N-morpholino)ethanesulfonic acid, and can ensure that a certain osmotic potential is formed on the plant surface, so that a basis is provided for the function of polypeptide. Meanwhile, the liquid culture medium can also serve as a solve to provide corresponding major and medium element nutrition, thereby ensuring the acting effect.

S3: Adding the obtained IDL6 mature polypeptide mother solution into the 2-(N-morpholino)ethanesulfonic acid solution and then stirring evenly to obtain the IDL6 mature polypeptide plant aging promoter. Wherein, the concentration of the IDL6 mature polypeptide is 10-13 μmol/L. In some embodiments of the present application, the concentration of 2-(N-morpholino)ethanesulfonic acid in the 2-(N-morpholino)ethanesulfonic acid solution is 2.8-3 mmol/L.

In some embodiments of the present application, the concentration of the IDL6 mature polypeptide mother solution prepared in S1 is 10-13 mmol/L.

It can be understood that the S1 and S2 may be interchanged with each other, and S1 may be performed first or S2 may be performed first. This will not be specifically limited here. In addition, the prepared IDL6 mature polypeptide mother solution needs to be prepared freshly just before use. If the mother solution is not to be used for more than 40 days, it is stored at −70° C.; if the mother solution is to be used within 40 days, it is stored at −20° C.; and, if the mother solution is to be used within one week, it is stored at 4° C.

In some embodiments of the present application, after the obtained IDL6 mature polypeptide mother solution is added into the 2-(N-morpholino)ethanesulfonic acid solution, the preparation method further includes a step of adding 1-2 v/v ‰ of Tween-20.

The present application further provides an application of the IDL6 mature polypeptide plant aging promoter in promoting plant aging. When in use, the IDL6 mature polypeptide plant aging promoter is directly sprayed on surfaces of plant leaves in the full extension stage, or a cotton ball is immersed in the IDL6 mature polypeptide plant aging promoter and then applied onto surfaces of plant leaves in the full extension stage.

The present application further provides an application of the IDL6 mature is polypeptide plant aging promoter in promoting plant aging. When in use, the IDL6 mature polypeptide plant aging promoter is directly sprayed on surfaces of tobacco leaves in the early mature stage, or a cotton ball is immersed in the IDL6 mature polypeptide plant aging promoter and then applied onto surfaces of tobacco leaves in the early mature stage. It should be understood that, no matter whether the plant aging promoter is directly spayed on surfaces of plant/crop leaves in the early mature stage or a cotton ball is immersed in the plant aging promoter and then applied onto surfaces of plant/crop leaves in the early mature stage, it is done on the premise that the growth state of the plant is not affected. Moreover, the plant aging promoter can promote the aging of plant leaves, which is particularly beneficial to the consistent harvesting of corps with asynchronously aged leaves, for example, tobacco. In some embodiments of the present application, the concentration of the IDL6 mature polypeptide plant aging promoter that is directly sprayed on surfaces of tobacco leaves in the early mature stage is 10-12 μmol/L. In some embodiments of the present application, the concentration of the IDL6 mature polypeptide plant aging promoter that is directly sprayed on surfaces of plant leaves in the full extension stage is 10-12 μmol/L.

Compared with the prior art, the present application has the following beneficial effects.

1. The IDL6 mature polypeptide in the IDL6 mature polypeptide plant aging promoter provided by the present application is an artificial synthesized mature polypeptide, which is easily available and can be synthesized on a large scale.

2. The plant aging promoter provided by the present application is simple in preparation and usage, high in field operability, and convenient and practical in operation. 3. The plant aging promoter provided by the present application has a moderate influence on leaf aging (no obvious difference from normally aged leaves) and will not lead to adverse effects.

### BRIEF DESCRIPTION OF THE DRAWINGS

FIG. 1 is a schematic diagram of the results of treating Arabidopsis thaliana in-vitro leaves with the IDL6 mature polypeptide plant aging promoter;

FIG. 2 is a schematic diagram of the results of measuring the chlorophyll content in the Arabidopsis thaliana in-vitro leaves treated with the IDL6 mature polypeptide plant aging promoter;

FIG. 3 is a schematic diagram of the results of treating tobacco in-vivo leaves with the IDL6 mature polypeptide plant aging promoter; and

FIG. 4 is a schematic diagram of the results of measuring the chlorophyll content in the tobacco in-vivo leaves treated with the IDL6 mature polypeptide plant aging promoter.

### DETAILED DESCRIPTION OF THE EMBODIMENTS

The technical solutions of the present application will be described in detail below in combination with specific embodiments. However, it should be understood that elements, structures and features in one embodiment may also be advantageously incorporated into other embodiments without further description.

The embodiments are only described as preferred embodiments of the present application, and are not intended to limit the scope of the present application. Various modifications and improvements made on the technical solutions of the present application by ordinary skill in the art without departing from the design spirit of the present application shall fall within the protective scope confirmed by the claims of the present application.

The technical solutions in the embodiments of the present application will be clearly and completely described below. Obviously, the described embodiments are only a part of the embodiments of the present application, rather than all the embodiments. Based on the embodiments in the present application, all other embodiments obtained by those of ordinary skill in the art without creative efforts shall fall within the protection scope of the present application.

It is to be noted that the term “mother solution” used in the embodiments refers to a solution with a higher concentration, and the solution needs to be diluted in subsequent use to serve as an operating solution with a lower concentration.

### Embodiment 1

An IDL6 mature polypeptide plant aging promoter was provided. The plant aging promoter included an IDL6 mature polypeptide and a 2-(N-morpholino)ethanesulfonic acid solution, wherein the concentration of IDL6 in the IDL6 mature polypeptide was 10 μmol/L, and the concentration of 2-(N-morpholino)ethanesulfonic acid in the 2-(N-morpholino)ethanesulfonic acid solution was 2.8 mmol/L. The 2-(N-morpholino)ethanesulfonic acid solution was a solution obtained by dissolving 2-(N-morpholino)ethanesulfonic acid monohydrate in an MS liquid culture medium, and the pH of the 2-(N-morpholino)ethanesulfonic acid solution was 5.8.

The preparation method included the following steps. (1) IDL6 mature polypeptide power was weighed and dissolved in water to prepare an IDL6 mature polypeptide mother solution, wherein the concentration of the IDL6 mature polypeptide in the mother solution was 10 mmol/L.

(2) A certain amount of 2-(N-morpholino)ethanesulfonic acid monohydrate was weighed and added to an MS liquid culture medium to prepare a 2-(N-morpholino)ethanesulfonic acid solution, wherein the concentration of the 2-(N-morpholino)ethanesulfonic acid was 2.8 mmol/L. The pH value of the solution was adjusted to be 5.8, fully mixed and dissolved evenly to obtain the 2-(N-morpholino)ethanesulfonic acid solution.

(3) 40 μL of the IDL6 mature polypeptide mother liquid obtained in step (1) was added to 40 mL of the 2-(N-morpholino)ethanesulfonic acid solution prepared in step (2) and stirred evenly by a glass bar to obtain 40 mL of the IDL6 mature polypeptide plant aging promoter.

### Embodiment 2

An IDL6 mature polypeptide plant aging promoter was provided. The plant aging promoter included an IDL6 mature polypeptide and a 2-(N-morpholino)ethanesulfonic acid solution, wherein the concentration of IDL6 in the IDL6 mature polypeptide was 12 μmol/L, and the concentration of 2-(N-morpholino)ethanesulfonic acid in the 2-(N-morpholino)ethanesulfonic acid solution was 2.9 mmol/L. The 2-(N-morpholino)ethanesulfonic acid solution was a solution obtained by dissolving 2-(N-morpholino)ethanesulfonic acid monohydrate in an MS liquid culture medium, and the pH of the 2-(N-morpholino)ethanesulfonic acid solution was 5.9.

The preparation method included the following steps.

(1) IDL6 mature polypeptide power was weighed and dissolved in water to obtain an IDL6 mature polypeptide mother solution, wherein the concentration of the IDL6 mature polypeptide in the mother solution was 10 mmol/L.

(2) A certain amount of 2-(N-morpholino)ethanesulfonic acid monohydrate was weighed and added to an MS liquid culture medium to prepare a 2-(N-morpholino)ethanesulfonic acid solution, wherein the concentration of the 2-(N-morpholino)ethanesulfonic acid was 2.5 mmol/L. The pH value of the solution was adjusted to be 5.9, fully mixed and dissolved evenly to obtain the 2-(N-morpholino)ethanesulfonic acid solution.

(3) 120 μL of the IDL6 mature polypeptide mother liquid obtained in step (1) was added to 100 mL of the 2-(N-morpholino)ethanesulfonic acid solution prepared in step (2) and stirred evenly by a glass bar to obtain 100 mL of the IDL6 mature polypeptide plant aging promoter.

### Embodiment 3

An IDL6 mature polypeptide plant aging promoter was provided. The plant aging promoter included an IDL6 mature polypeptide and a 2-(N-morpholino)ethanesulfonic acid solution, wherein the concentration of IDL6 in the IDL6 mature polypeptide was 13 μmol/L, and the concentration of 2-(N-morpholino)ethanesulfonic acid in the 2-(N-morpholino)ethanesulfonic acid solution was 3 mmol/L. The 2-(N-morpholino)ethanesulfonic acid solution was a solution obtained by dissolving 2-(N-morpholino)ethanesulfonic acid monohydrate in an MS liquid culture medium, and the pH of the 2-(N-morpholino)ethanesulfonic acid solution was 5.8.

The preparation method included the following steps.

(1) IDL6 mature polypeptide power was weighed and dissolved in water to obtain an IDL6 mature polypeptide mother solution, wherein the concentration of the IDL6 mature polypeptide in the mother solution was 10 mmol/L.

(2) A certain amount of 2-(N-morpholino)ethanesulfonic acid monohydrate was is weighed and added to an MS liquid culture medium to prepare a 2-(N-morpholino)ethanesulfonic acid solution, wherein the concentration of the 2-(N-morpholino)ethanesulfonic acid was 3 mmol/L. The pH value of the solution was adjusted to be 5.8, fully mixed and dissolved evenly to obtain the 2-(N-morpholino)ethanesulfonic acid solution.

(3) 78 μL of the IDL6 mature polypeptide mother liquid obtained in step (1) was added to 60 mL of the 2-(N-morpholino)ethanesulfonic acid solution prepared in step (2) and stirred evenly by a glass bar to obtain 60 mL of the IDL6 mature polypeptide plant aging promoter.

### Performance Test

### Laboratory Test

By taking Embodiment 1 as an example, Arabidopsis thaliana in-vitro leaves and tobacco in-vivo leaves were treated with the IDL6 mature polypeptide plant aging promoter prepared in Embodiment 1, respectively.

The Arabidopsis thaliana leaves were treated in the following way.

Control group 1: Arabidopsis thaliana grew under continuous illumination for about 30 days. In-vitro leaves with the same growth potential at the same leaf site (the sixth leaf site) were selected by a pair of forceps and placed flatly on a culture dish. 2.8 mmol/L 2-(N-morpholino)ethanesulfonic acid solution (MES) was directly spayed on the surfaces of the Arabidopsis thaliana in-vitro leaves, and the leaves were kept under continuous illumination for 4 days to observe the phenotype.

Test group 1: Arabidopsis thaliana grew under continuous illumination for about 30 days. In-vitro leaves with the same growth potential at the same leaf site (the sixth leaf site) were selected by a pair of forceps and placed flatly on a culture dish. The IDL6 mature polypeptide plant aging promoter at 10 μmol/L was directly spayed on the surfaces of the Arabidopsis thaliana in-vitro leaves, and the leaves were kept under continuous illumination for 4 days to observe the phenotype.

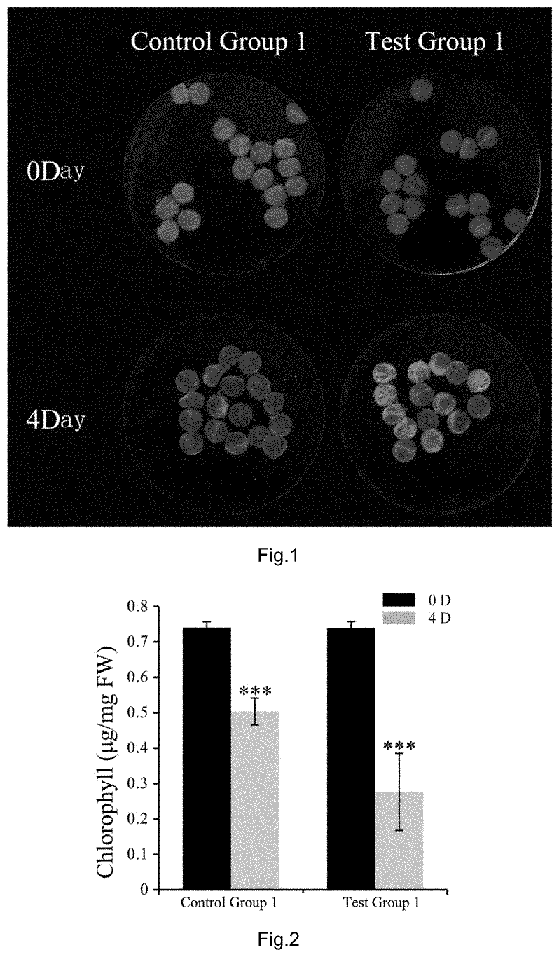

It could be known from the results that, as shown in FIG. 1, the IDL6 mature polypeptide plant aging promoter could promote the aging of Arabidopsis thaliana is leaves. Four days later, the Arabidopsis thaliana in-vitro leaves sprayed with the IDL6 mature polypeptide plant aging promoter in the test group 1 showed obvious premature senescence phenotype. Meanwhile, the chlorophyll contents of the leaves in the control group 1 and the test group 1 were measured by ethanol. As shown in FIG. 2, compared with the control group 1, the chlorophyll content of the leaves treated with the IDL6 mature polypeptide plant aging promoter in the test group 1 decreased after the leaves were kept under continuous illumination for 3 days. The chlorophyll content in the control group 1 decreased to 0.503 μg/mg, while the chlorophyll content in the test group 1 decreased to 0.276 μg/mg.

### Field Test

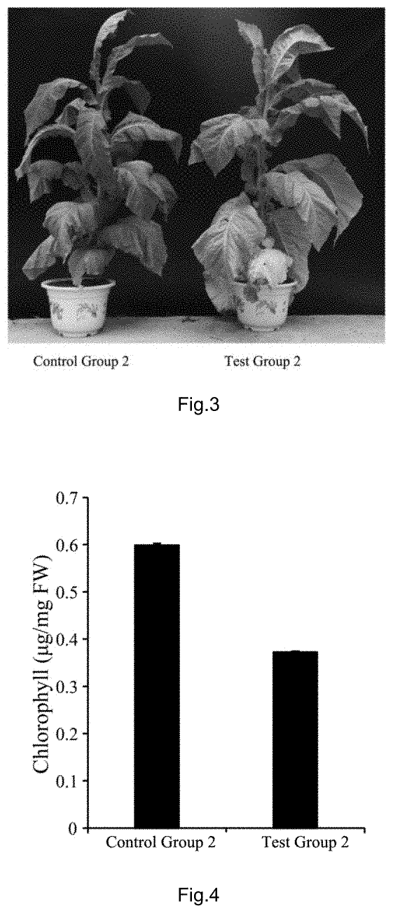

Tobacco K326 cultivated for about 60 days in the field was used as raw material. The tobacco was sprayed with the IDL6 mature polypeptide plant aging promoter at 10 μmol/L and used as a test group 2, and the tobacco was sprayed with a solution not containing the IDL6 mature polypeptide and used as a control group 2. As shown in FIG. 3, fourteen days later, it could be observed that the tobacco sprayed with the IDL6 mature polypeptide plant aging promoter in the test group 2 showed premature senescence phenotype. Meanwhile, the chlorophyll contents of tobacco leaves in the test group 2 sprayed with the IDL6 mature polypeptide plant aging promoter and in the control group 2 after fourteen days were measured by ethanol. As shown in FIG. 4, the results showed that, compared with the control group 2 (0.598 μg/mg), the chlorophyll content (0.372 μg/mg) of tobacco leaves treated with the IDL6 mature polypeptide plant aging promoter in the test group 2 was reduced obviously. The results showed that the IDL6 mature polypeptide plant aging promoter really had an obvious effect of promoting the aging of in-vivo plant leaves.

1. An IDL6 mature polypeptide plant aging promoter, wherein the plant aging promoter is with an IDL6 mature polypeptide as a main functional component, and the IDL6 mature polypeptide has the following amino acid sequence:
F-G-S-L-V-L-N-A-L-P-K-G-S-V-P-A-S-G-P-S-K-R-I-N;
the plant aging promoter includes the IDL6 mature polypeptide and a 2-(N-morpholino)ethanesulfonic acid solution, wherein the 2-(N-morpholino)ethanesulfonic acid solution is a solution obtained by dissolving 2-(N-morpholino)ethanesulfonic acid monohydrate in an MS liquid culture medium;
a concentration of the IDL6 mature polypeptide in the plant aging promoter is 10-13 μmol/L, a concentration of 2-(N-morpholino)ethanesulfonic acid in the 2-(N-morpholino)ethanesulfonic acid solution is 2.8-3 mmol/L, and a pH of the 2-(N-morpholino)ethanesulfonic acid solution is 5.8-5.9.

2. The plant aging promoter according to claim 1, wherein the concentration of the IDL6 mature polypeptide in the plant aging promoter is 10 μmol/L, the concentration of 2-(N-morpholino)ethanesulfonic acid in the 2-(N-morpholino)ethanesulfonic acid solution is 2.8 mmol/L, and the pH of the 2-(N-morpholino)ethanesulfonic acid solution is 5.8.

3. The plant aging promoter according to claim 1, wherein the plant aging promoter further includes an auxiliary agent, the auxiliary agent is Tween-20, and an added amount of the auxiliary agent is 1-2 v/v ‰.

4. The plant aging promoter according to claim 2, wherein the plant aging promoter further includes an auxiliary agent, the auxiliary agent is Tween-20, and an added amount of the auxiliary agent is 1-2 v/v ‰.

5. A preparation method for the IDL6 mature polypeptide plant aging promoter according to claim 1, specifically including the following steps:
Dissolving IDL6 mature polypeptide power in water to prepare an IDL6 mature polypeptide mother solution with a concentration of 10-13 mmol/L;
Adding 2-(N-morpholino)ethanesulfonic acid monohydrate to a prepared MS liquid culture medium to prepare 2-(N-morpholino)ethanesulfonic acid solution, wherein a concentration of 2-(N-morpholino)ethanesulfonic acid in the 2-(N-morpholino)ethanesulfonic acid solution is 2.8-3 mmol/L; adjusting a pH value of the 2-(N-morpholino)ethanesulfonic acid solution to be 5.8-5.9, and mixing fully and dissolving evenly to obtain the 2-(N-morpholino)ethanesulfonic acid solution;
Adding the obtained IDL6 mature polypeptide mother solution into the 2-(N-morpholino)ethanesulfonic acid solution and stirring evenly to obtain the IDL6 mature polypeptide plant aging promoter.

6. The preparation method according to claim 5, wherein after adding the obtained IDL6 mature polypeptide mother solution into the 2-(N-morpholino)ethanesulfonic acid solution, the preparation method further includes a step of adding 1-2 v/v ‰ of Tween-20.

7. An application of the IDL6 mature polypeptide plant aging promoter according to claim 1 in promoting plant aging, wherein during application, the IDL6 mature polypeptide plant aging promoter is directly sprayed on surfaces of plant leaves in full extension stage, or a cotton ball is immersed in the IDL6 mature polypeptide plant aging promoter and then applied onto surfaces of plant leaves in full extension stage.

8. The application according to claim 7, wherein a concentration of the IDL6 mature polypeptide plant aging promoter directly sprayed on surfaces of plant leaves in full extension stage is 10-12 μmol/L.

9. The application according to claim 7, wherein during application, the IDL6 mature polypeptide plant aging promoter is directly sprayed on surfaces of tobacco leaves in early mature stage, or a cotton ball is immersed in the IDL6 mature polypeptide plant aging promoter and then applied onto surfaces of tobacco leaves in early mature stage.

10. The application according to claim 9, wherein a concentration of the IDL6 mature polypeptide plant aging promoter directly sprayed on surfaces of tobacco leaves in early mature stage is 10-12 μmol/L.
